(19) United States
(12) Patent Application Publication
(10) Pub. No.: US 2007/0115493 A1
(43) Pub. Date: May 24, 2007

(54) Image forming apparatus, client device, client device control method, and storage medium storing driver program in client device

(76) Inventors: Takanori Haginaka, Kawasaki-shi (JP); Ryu Inada, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/436,831

(22) Filed: May 18, 2006

(30) Foreign Application Priority Data
Nov. 18, 2005 (JP) 2005-333938

(51) Int. Cl. G06K 15/00

(52) U.S. Cl. 358/1.14; 358/1.15

(57) ABSTRACT

A method for controlling an image forming system in which a client device creates print data using a print restriction and causes an image forming apparatus to print the print data, has an inquiring step of issuing an inquiry from the client device to the image forming apparatus in response to a print instruction from a user as to whether the print restriction is updated, and a print data output step in which, when the print restriction is not updated, the client device creates print data using the print restriction stored in the client device and outputs the print data, and, when the print restriction is updated, the client device updates the print restriction stored in the client device to that obtained from the image forming apparatus, creates the print data using the updated print restriction, and outputs the print data to the image forming apparatus.

### PRIORITY INFORMATION

This application claims priority to Japanese Patent Application No. 2005-333938 filed on Nov. 18, 2005, which is incorporated herein by reference in its entirety.

### BACKGROUND

1. Technical Field

The present invention relates to an image forming system in which a print restriction specified for each user in an image forming apparatus is reflected in the settings of a client device.

2. Related Art

Conventionally, a printer, a multifunction machine, or the like shared by multiple users has been used in conjunction with a-printing management server or the like to realize functions of measuring and managing monochrome (black and white) and color printed records, usage track records organized by user or by division, and others. Such a printer or a multifunction machine often further includes a restriction function for specifying an output limit for each user employing the above-described functions of measuring and managing, to prohibit the printer or the multifunction machine from outputting documents beyond that output limit.

### SUMMARY

A method for controlling an image forming system wherein a print restriction is stored in a client device and an image forming apparatus, and print data is created by the client device using the print restriction stored in the client device and printed from the image forming apparatus, is provided. The method includes an inquiry step of issuing an inquiry from the client device to the image forming apparatus according to a print instruction from a user to determine whether or not the print restriction stored in the client device differs from the print restriction stored in the image forming apparatus, and a print data output step in which the print restriction stored in the client device is updated to the print restriction obtained from the image forming apparatus by the client device when there is a difference between the print restrictions, the print data is created using the updated print restriction, and the created print data is output to the image forming apparatus.

### BRIEF DESCRIPTION OF THE DRAWINGS

An embodiment of the present invention will be described in detail based on the following figures, wherein:

FIG. 1 schematically shows a configuration of an image forming system according to an embodiment of the present invention;

FIG. 2 is a message diagram for explaining a flow of information exchanged between an image forming apparatus and a client device according to the embodiment of the present invention;

FIG. 3 is another message diagram for explaining the flow of information exchanged between the image forming apparatus and the client device according to the embodiment of the present invention;

FIG. 4 is a still another message diagram for explaining the flow of information exchanged between the image forming apparatus and the client device according to the embodiment of the present invention;

FIG. 5 is a diagram showing an example of screen display associated with an update of a print restriction displayed by a printer driver according to the embodiment of the present invention; and

FIG. 6 is a diagram showing an example of screen display associated with print settings of the printer driver according to the embodiment of the present invention.

### DETAILED DESCRIPTION

Referring to the drawings, an embodiment of the present invention will be described below.

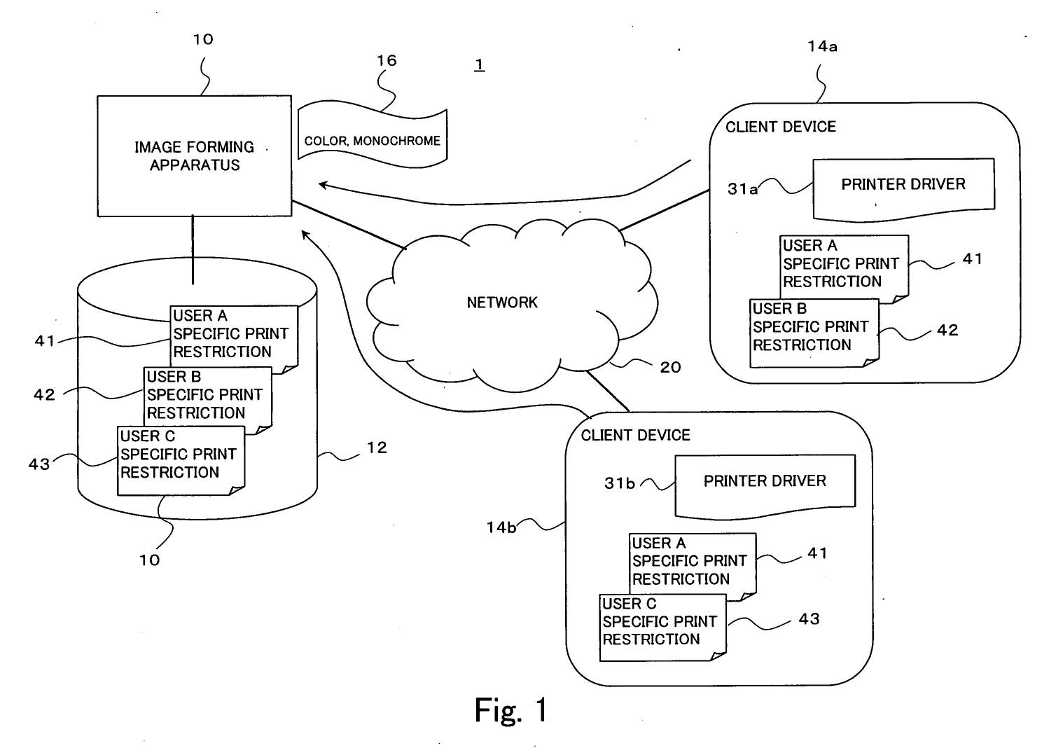

FIG. 1 is a diagram schematically showing a configuration of an image forming system 1 according to the present embodiment. The image forming system 1 includes a client device 14, an image forming apparatus 10 which performs color and monochrome printing, and a print restriction database 12 in which print restrictions for each user are managed. The client device 14 is connected via a network 20 to the image forming apparatus 10. The image forming apparatus 10 may be implemented by a multifunction machine combining the functions of a color/monochrome printer, a copier, a scanner, a facsimile, and the like.

The print restriction database 12 stores user specific print restrictions. An operator can change the user specific print restrictions as required. As shown in FIG. 1, the print restriction database 12 stores a user A specific print restriction 41, a user B specific print restriction 42, and a user C specific print restriction 43.

Each client device 14 stores at least one of the print restrictions associated with each user of the client device 14. Further, the client device 14 has a printer driver 31 which creates data to be printed by an image forming unit in the image forming apparatus 10. Each printer driver 31 retrieves the print restrictions, or the user specific print restrictions (user A, B, and C specific print restrictions. 41 to 43) stored in the image forming apparatus in response to a print data output request from the user (user A˜user C) to create print data using the retrieved print restrictions, and outputs the created print data to the image forming apparatus 10.

In the example shown in FIG. 1, the user A uses both of the client devices 14a and 14b, while the user B uses only the client device 14a, and the user C uses only the client device 14b.

In response to a print request from the client device, the image forming apparatus 10 looks up the print restriction for each user stored in the print restriction database 12, and determines whether or not the print request satisfies the print restriction. If the print request satisfies the print restriction, the image forming apparatus 10 enables printing and outputs a color or monochrome printout 16. If the print request does not satisfy the print restriction, on the other hand, the image forming apparatus 10 disables the printing.

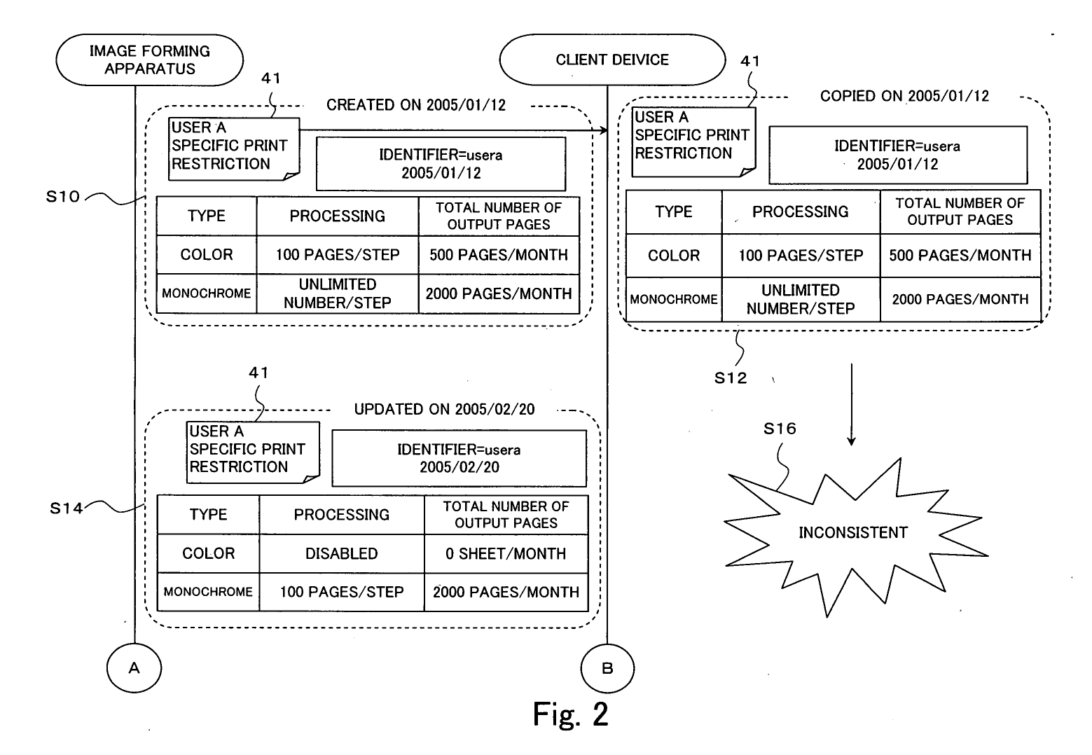

FIGS. 2 to 4 are message diagrams for explaining a flow of information exchanged between the image forming apparatus and the client device according to this embodiment.

In a process shown in FIG. 2, an operator previously specifies settings for all users who perform printing using the image forming apparatus 10. Here, the process will be described with respect to a user A as an example. The operator creates the user A specific print restriction 41 necessary for the user A to output a print using the image forming apparatus 10 (step S10). FIG. 2 shows an example of the user A specific print restriction 41 which may include, for example, an identifier for identifying the print restriction of the user, an upper limit for the number of pages which can be output in one step, and an upper limit for the monthly total number of output pages, separately organized for color and monochrome printing.

Although, in FIG. 2, the user A specific print restriction 41 stored in the image forming apparatus 10 is sent to the client device 14a and registered in the client device 14a (step S12), this step S12 is provided here as one example and may be eliminated. When step S12 is not provided, the user A specific print restriction 41 may be obtained, for example, according to an instruction from the user via a printer driver 31a, which will be described later, and registered in the client device 14a.

The identifier of the user A specific print restriction 41 may be configured with a combination of a user name and a date and time when the print restriction is created or updated, such as, for example, “usera2005/01/12” as shown in FIG. 2. The identifier is not limited to the combination of the user name and the date and time, however, and may be configured with a combination of the user name and a version number of the print restriction, or a value with which a state of update can be judged, such as a hash value of the print restriction.

Then, the operator can make modifications to the user A specific print restriction 41 in the image forming apparatus 10. If the operator modifies the user A specific print restriction 41, for example, such that color printing is prohibited and the number of pages output in one process for monochrome printing is changed from unlimited pages to 100 pages, and the modified settings are not sent to the client device 14a after the modifications have been made, there arises a discrepancy between the modified user A specific print restriction 41 and the user A specific print restriction 41 stored in the client device 14a (step S16).

In this situation, if the user A issues a request for color printing, the request is generally rejected by the image forming apparatus 10.

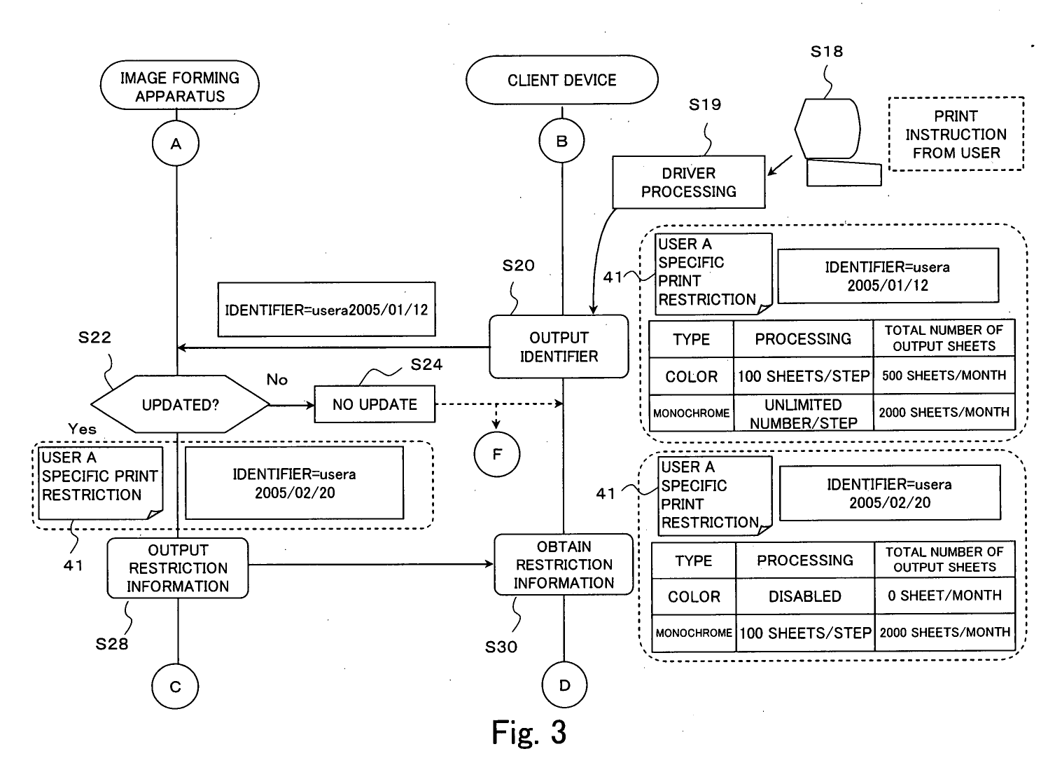

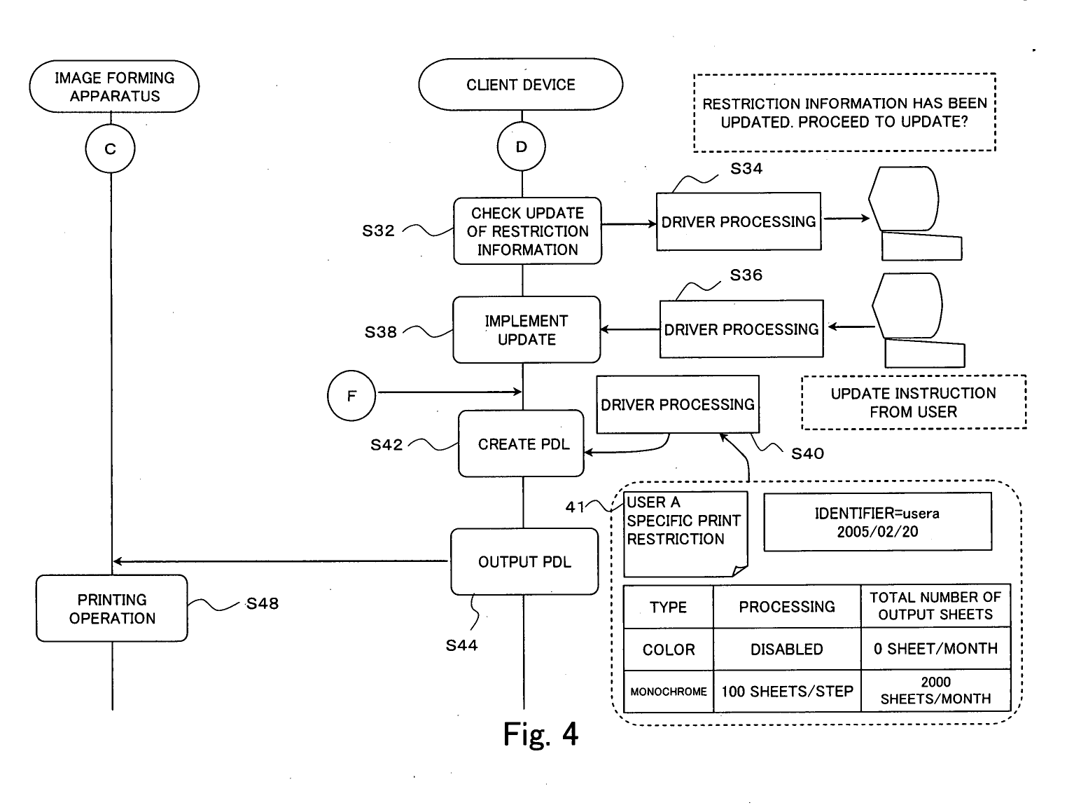

As a possible configuration for eliminating the occurrence of such a rejection, the image forming apparatus 10 may force regular transmission of the print restriction retained in the image forming apparatus 10 to the client devices 14a, 14b, and others, regardless of the presence or absence of the modifications. However, such a configuration is not preferable because the forced regular transmission significantly increases the load on the network in cases where the print restriction must be sent to a great number of client devices and where the variety of the print restrictions to be specified is great. Accordingly, processes shown in FIGS. 3 and 4 may be more preferably performed in the present embodiment.

In the process shown in FIG. 3, when the user A instructs color printing, for example, in step S18, the printer driver 31a reads out the user A specific print restriction 41 stored in the client device 14a (step S19) and sends the identifier of the read out user A specific print restriction 41 from the client device 14a to the image forming apparatus 10 (step S20). If the client device 14a stores no print restriction, the printer driver 31a transmits information of “no identifier” (not illustrated) to the image forming apparatus 10.

Next, the image forming apparatus 10 compares the transmitted identifier “usera2005/01/12” (or information of “no identifier”) with an identifier “usera2005/02/20” of the user A specific print restriction 41 stored in the print restriction database 12 to determine whether or not the print restriction is updated (step S22). The print restriction may be determined to have been updated when there is a difference between the identifiers. Alternatively, only date and time portions of the identifiers may be compared, and the print restriction may be determined to have been updated when the date and time portion of the identifier stored in the print restriction database 12 denotes a later date and time relative to that denoted by the date and time portion of the transmitted identifier.

After determining the update in step S22, the image forming apparatus 10 outputs the user A specific print restriction 41 to the client device 14a (step S28). The client device 14a, on the other hand, receives and stores the user A specific print restriction 41 output from the image forming apparatus 10 (step S30).

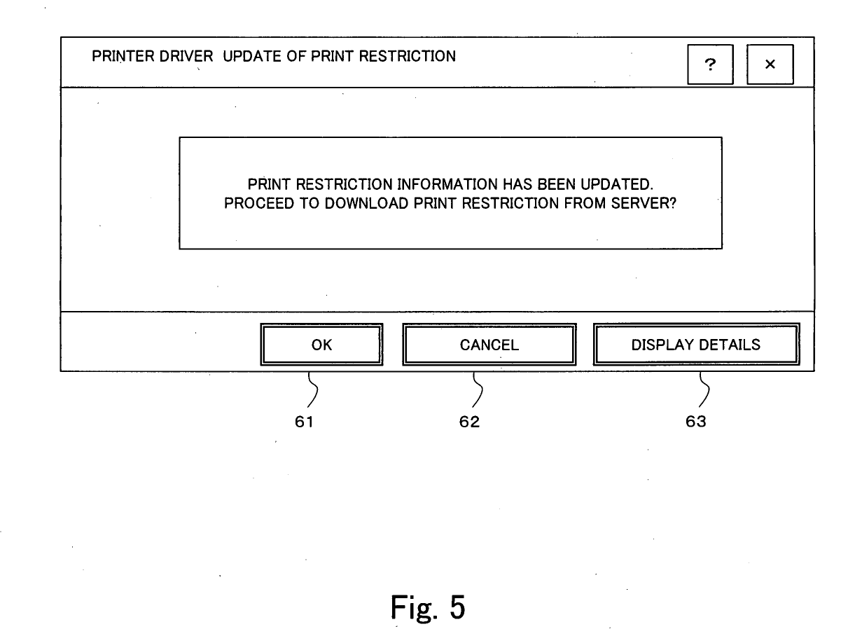

In the process of FIG. 4, the printer driver 31a compares the identifier of the user A specific print restriction 41 newly stored in step S30 with the identifier of the prestored user A specific print restriction 41 (step S32). Upon detection of the update to the print restriction, the printer driver 31 displays a window (refer to FIG. 5) to notify the user of the update of print restriction information (step S34).

In the window shown in FIG. 5, the printer driver 31a provides the user with two messages “restriction information has been updated” and “proceed to download the print restriction from the server?”. To cancel downloading of the print restriction, the user can click a “cancel” button 62 which causes the print driver 31a to end processing.

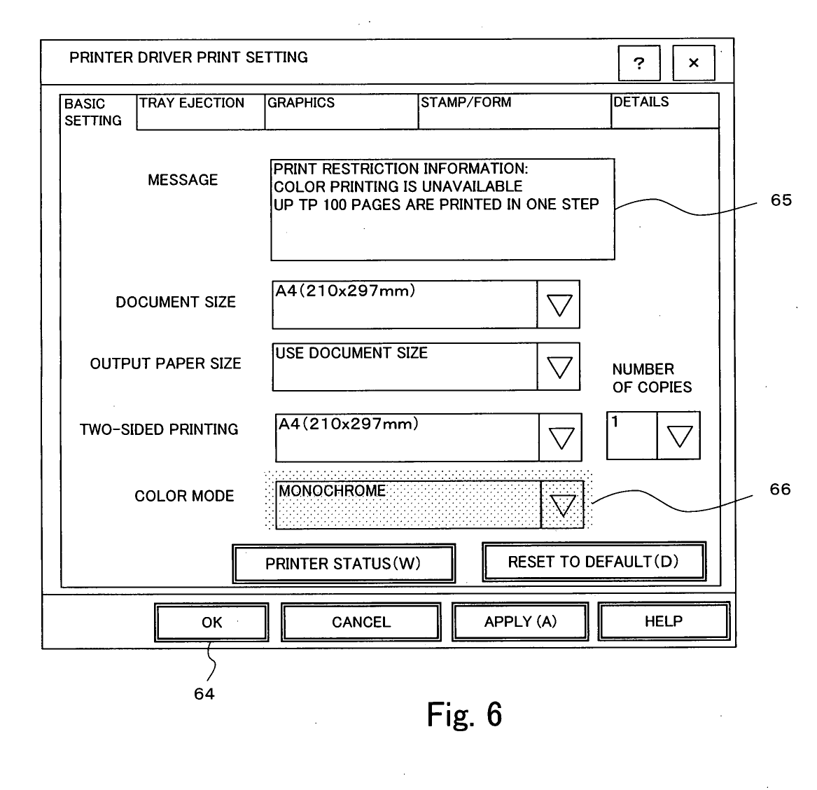

When it is necessary to check detailed information in the window shown in FIG. 5, the user can click a “display details” button 63, which invokes another window including detailed information of the printer driver 31a as shown in FIG. 6. Then, the printer driver 31a reflects the restriction information obtained in accordance with determination of the update to the print restriction onto print settings of the printer driver 31a and displays the print settings including updated information (step S32).

As a result, the printer driver 31a displays information of the print restriction that “color printing is unavailable. Up to 100 pages are printed in one step” in a message area 65 shown in FIG. 6, and displays a “color mode” pull-down switch 66 set to a monochrome mode in a state where changing of the mode is disabled.

When an OK button 64 is selected to close the window of print settings shown in FIG. 6, the window of FIG. 5 reappears. Next, when the user clicks an OK button 61 of FIG. 5 to update the restriction information, the printer driver 31a detects the input as an instruction for updating the restriction information (step S36 in FIG. 4) and performs update processing (step S38 in FIG. 4). Consequently, the printer driver 31a updates the print restriction stored in the printer driver 31a based on the user A specific print restriction 41 stored in the previous step (step S38 in FIG. 4).

Next, in step S42, the printer driver 31a generates print data described in a page description language (PDL) using the updated user A specific print restriction 41. The generated print data is output by the printer driver 31a to the image forming apparatus 10. Upon receipt of the print data, the image forming apparatus 10 performs printing after confirming that the print restriction is satisfied (step S48).

In the determination as to whether or not the print restriction is updated (step S22) in FIG. 3, when “no update” is determined, the operation proceeds to step S42. In step S42, the printer driver 31a generates print data without updating the user A specific print restriction 41, and outputs the generated print data to the image forming apparatus 10. Upon receipt of the print data, the image forming apparatus 10 performs printing after confirming that the print restriction is satisfied (step S48).

Because the printer driver 31 outputs the identifier including the user name for each print request from the user, it is preferable that processing for protecting data, such as encryption, be employed in communication between the image forming apparatus 10 and the client device 14.

In the above-described embodiment, information regarding restrictions on print functions that are supplied to the user by the image forming apparatus 10 is registered as the print restriction in the image forming apparatus 10 and the client device 14a. As an example modification, user specific setting information, such as a user specific header or footer to be inserted in a page image in printing operation, may be added to the print restriction. With this configuration, when user specific setting information is newly specified or altered in the image forming apparatus 10, the specified or altered setting information is automatically registered in the client device 14a used by the corresponding user according to the scheme of the above-described example.

Although, in the above example modification, the restrictions on the print functions of the image forming apparatus 10 and the user specific setting information are registered as the print restriction in the image forming apparatus 10 and the client device 14a, driver management information, such as a version number used for managing the update to the printer driver 31 in the client device 14a, may be added in the image forming system 1, to separately detect the presence or absence of updates to the print restriction and the printer driver 31a.

More specifically, in response to the print request from the user, the client device 14a sends the identifier of the print restriction 41 stored in the client device 14a and the management information of the printer driver 31a to the image forming apparatus 10. Upon receipt of the identifier and the management information, the image forming apparatus 10 compares the received identifier and management information with the identifier and management information retained in the image forming apparatus 10 to individually determine, for each of the print restrictions and the printer driver 31a, whether or not an update is present. When the image forming apparatus 10 detects an update to the print restriction, the update is automatically registered in the client device 14a according to the scheme of the above-described embodiment. On the other hand, when the image forming apparatus 10 detects the update to the printer driver 31, the update to the printer driver 31a is sent to the client device 14a. Upon receipt of the update, the client device 14a notifies the user of a request for updating the printer driver 31a and updates the printer driver 31a according to instructions from the user.

Although the embodiment of the present invention was described with a certain degree of detail using specific examples, it is to be understood that the invention is not limited thereto. It is further understood by those skilled in the art that various changes and modifications may be made in the invention without departing from the spirit and scope thereof.

What is claimed is:

1. A method for controlling an image forming system wherein a print restriction is stored in a client device and an image forming apparatus, and print data is created by the client device using the print restriction stored in the client device and printed from the image forming apparatus, the method comprising:
an inquiry step of issuing an inquiry from the client device to the image forming apparatus according to a print instruction from a user to determine whether or not the print restriction stored in the client device differs from the print restriction stored in the image forming apparatus; and
a print data output step in which the print restriction stored in the client device is updated to the print restriction obtained from the image forming apparatus by the client device when there is a difference between the print restrictions, the print data is created using the updated print restriction, and the created print data is output to the image forming apparatus.

2. An image forming system in which a print restriction is stored in a client device and an image forming apparatus, print data is created at the client device using the print restriction stored in the client device, and the created print data is printed by the image forming apparatus, the system comprising:
a restriction update unit which creates and updates the print restriction;
an inquiring unit which queries the image forming apparatus in response to a print instruction from a user to determine whether or not the print restriction stored in the client device differs from the print restriction stored in the image forming apparatus;
an inquiry responding unit which responds to an inquiry from the client device concerning the print restriction; a restriction output unit which outputs, to the client device, the print restriction in response to a request from the client device, and
a print data output unit which, when there is a difference between the print restrictions, updates the print restriction stored in the client device to the print restriction obtained from the image forming apparatus, creates the print data using the updated print restriction, and outputs the created print data to the image forming apparatus.

3. An image forming apparatus comprising:
a restriction update unit which creates and updates a print restriction;
an inquiry responding unit which responds to an inquiry from a client device; and
a restriction output unit which outputs, to the client device, the print restriction stored in the image forming apparatus in response to a request from the client device.

4. A client device comprising:
an inquiring unit which queries an image forming apparatus in response to a print instruction from a user to determine whether or not a print restriction stored in the client device differs from a print restriction stored in the image forming apparatus; and
a print data output unit which, when there is a difference between the print restrictions, updates the print restriction stored in the client device to the print restriction obtained from the image forming apparatus, creates print data using the updated print restriction, and outputs the created print data to the image forming apparatus.

5. The client device according to claim 4, further comprising a storage which stores print restrictions for a plurality of users, wherein
the inquiring unit queries the image forming apparatus in response to the print instruction from each user to determine whether or not the print restriction for the user stored in the storage differs from the print restriction for the user stored in the image forming apparatus; and
the print data output unit updates the print restriction for the user to the print restriction obtained from the image forming apparatus and creates the print data using the updated print restriction.

6. A method for controlling an image-forming apparatus, comprising:
creating and updating a print restriction;
responding to an inquiry regarding the print restriction sent from a client device; and
outputting the print restriction in response to a request from the client device.

7. A method for controlling a client device, comprising:
querying an image forming apparatus in response to a print instruction from a user to determine whether or not a print restriction stored in the client device differs from a print restriction stored in the image forming apparatus; and
when there is a difference between the print restrictions, updating the print restriction stored in the client device to the print restriction obtained from the image forming apparatus when there is a difference between the print restrictions, creating print data using the updated print restriction, and outputting the created print data to the image forming apparatus.

8. The method of controlling a client device according to claim 7, further comprising:
storing print restrictions for a plurality of users;
querying the image forming apparatus in response to a print instruction from each user as to whether or not the print restriction for the the user is updated; and
when the print restriction is updated, updating the print restriction for the user to the print restriction obtained from the image forming apparatus, and creating the print data 25 using the updated print restriction.

9. A storage medium readable by a computer, the storage medium storing a program of instructions executable by the computer to perform a function for controlling an image forming apparatus, the function comprising:
creating and updating a print restriction;
responding to an inquiry from a client device regarding the print restriction; and
outputting the print restriction to the client device in response to a request from the client device.

10. A storage medium readable by a computer, the storage medium storing a program of instructions executable by the computer to perform a function as a driver program in a client device, the function comprising:
querying an image forming apparatus in response to a print instruction from a user as to whether or not a print restriction is updated; and
when the print restriction is updated, updating the print restriction stored in the client device to the print restriction obtained from the image forming apparatus, creating the print data using the updated print restriction, and outputting the created print data to the image forming apparatus.

11. The storage medium according to claim 10, the function further comprising:
storing print restrictions for a plurality of users;
querying the image forming apparatus in response to a print instruction from each user as to whether or not the print restriction for the the user is updated; and
when the print restriction is updated, updating the print restriction for the user to the print restriction obtained from the image forming apparatus, and creating the print data using the updated print restriction.

12. A method for controlling a client device comprising:
updating a print restriction stored in a storage to a print restriction obtained from an image forming apparatus;
creating print data using the updated print restriction;
outputting the created print data to the image forming apparatus for printing the created print data;
querying the image forming apparatus in response to a print instruction from a user as to whether or not the print restriction stored in the client device differs from the print restriction stored in the image forming apparatus; and
prohibiting the updating when-no difference is found between the print restrictions as a result of the the querying.
